(19) United States
(12) Patent Application Publication
(10) Pub. No.: US 2012/0085007 A1
(43) Pub. Date: Apr. 12, 2012

(54) DOOR OPENING INDICATOR DEVICE

(76) Inventor: Fernando OYARZUN SCHOLTBACH, Puerto Montt (CL)

(21) Appl. No.: 13/270,626

(22) Filed: Oct. 11, 2011

Related U.S. Application Data
(63) Continuation of application No. 12/248,419, filed on Oct. 9, 2008, now abandoned.
Application No. 12/248,419 is a continuation of application No. PCT/ES2007/070073, filed on Apr. 11, 2007.

(30) Foreign Application Priority Data
Apr. 11, 2006 (CL) 821-2006

(51) Int. Cl. G09F 13/20; G09F 7/00

(52) U.S. Cl. 40/542; 40/584

(57) ABSTRACT

A door opening indicator device comprising a signaler that uses a color code based on the color red and the color green for an anticipated arrangement of people accessing through them.

### CROSS-REFERENCE TO RELATED APPLICATIONS

This application is a continuation application of U.S. Ser. No. 12/248,419, filed Oct. 9, 2008 (pending), which claims the priority of PCT Patent Application PCT/ES2007/070073, filed Apr. 11, 2007, which claims the priority of Chilean Patent Application CN 821-2006, filed Apr. 11, 2006, the disclosures of which are incorporated herein by reference.

### FIELD OF THE INVENTION

The present disclosure relates to signposting for people's transit field, specifically to a door opening direction's indicator for an orderly access through them, by a color code.

### PREVIOUS ART DESCRIPTION

Today it has become essential the signposting for the behavior and working of various systems that are often around us and this signing must be above the language barrier or the understanding of the local language. It is with that in mind that many signaling devices use drawings to show escape routes in buildings such as hotels, airports, cinemas, malls, etc. or other emergency and/or warning and/or information symbols.

The symbol or figure language has a universal understanding, and as such it is used worldwide.

Another form of worldwide language is the information that can be given by using determined colors, associated or not with lights, and it is widely used on road signposts such as stoplights. In fact, the colors used for that have been standardized: For example, red for stopping or danger (forbidden) and green for passing o free (allowed).

An example of the latter can be found on the patent Document WO 01/71101, titled “Boarding hall call registration methods and its device” (Yoshida and others), which describes an access hall for a series of elevators, where there is a number and color indicator panel for each elevator, wherein each elevator also has its number and color laid out on top of its doors. The indicator panel provides buttons that can be lighted for each elevator and next to each button an assigned sector's indicator light. When a passenger wants to go to a floor on sector 1, he presses the button that corresponds to the sector, which is identified and transmitted to a sector indication's control. When the sector entry is registered, the pressed button lights up. When an elevator is assigned to sector 1, and indicator corresponding to sector 1 lights up and simultaneously the indicator on top of the elevator's door also lights up.

For the particular case of doors, and giving information respecting the opening direction of them in the case of swinging doors, it is used a sign at a medium height with a word in one language at most in two languages, that indicates if people has to pull or push for opening said door, which is comprehensible for people that knows the language in question.

The same happens for automatic swinging or sliding doors that use signs with words such as “entrance” or “exit”, because the have a proximity sensor, which makes the door work, only at one side of them.

On the previous cases the supplied information is not of use for everyone that needs to transit through the doors, for example, for those that do not know the language.

Because of the latter it is provided a door opening direction's indicator for an anticipated arrangement of the people accessing through them, by means of a Color code, using the colors red and green, widely known in the world, which indicate in a quick and precise manner the transit through them.

### BACKGROUND OF THE INVENTION

The development of the present invention was born upon the observance of the inefficiencies of people's transit through doors, when the existence of signaling that does not supply the necessary information for a safe and fluid transit through the doors was proved, we refer to the signposts that indicate the following texts: “tire-empuje/push-pull”.

Otherwise, there is no globally accepted and acknowledged signaling that adds its uniformity value.

The signaling that is used at the present time possesses serious limitations that reduce its efficiency; some of them are among the following:

The text “Push” indicated on the doors does not allow informing if these doors can be pushed by those who use the door on the opposite direction, situation that carries a risk of accident for who tries to operate in opposite direction within little gap of time. The described situation means that the current signaling can not inform when a door operates in both ways with a 180.degree. swing.

The current signaling does not incorporate among its codes the possibility of informing when a door is blocked. This case is recurrently found in doors that are set consecutively with the finality of protecting or stopping the heat or air conditioning from escaping the place. The presence of blocked doors without information relative to its way of operating means permanent tries from people trying to open them, that produces discomfort and inefficiencies that are expressed a time net losses, losses that measured in global terms mean, surely, thousands of hour/man/year, economically quantifiable. To the cost previously described must be added the costs of accidents that are caused by a seriously limited signaling.

When the doors have a sing with the word “Pull” on it, it is not possible to determine if those that open it from the opposite direction can only push it or pull it, this last situation being a door with a 180.degree. swing.

The current signaling and signposts are not able to deliver a 100% of the necessary information to make a safe and fluid passage through the doors, every time it is not among its codes to signal how the doors are operated from the opposite direction that they are being used.

The current signaling imposes idiomatic barriers that if added to the previously described deficiencies make it a product undervalued by the global community.

The present disclosure is born from the search for a logical formulation that allows conceiving a practical application that surpasses the detected deficiencies.

A invention patent documents search was performed on the main world's databases like the EP (European Patent Office), US (United States Patent and Trademark Office) and DPI (Industrial Property Department in Chile), said search meant the analysis of more than 1000 documents and no patents similar to what is being developed here were found.

One of the main virtues of the developed device, relates to the anticipated delivery (at a minimum distance of approximately 4 to 5 meters before contacting the doors) of a 100% of the information needed to know the full operation of the doors, from the direction they are being used, but also from the perspective of the people that uses them from the opposite direction. The latter means that the device gives information about what the door can do from the direction that it is being used, and simultaneously it is able to supply information pertaining the way these doors can be operated by those that use them from the opposite direction, surpassing the usefulness of the current device also known as the signs “push/pull” or “tire/empuje”.

What was just mentioned allows for reducing in a substantial way the risks of accidents caused by the lack of information, and enhancing the average speed for making a safe and fluid passage through these doors.

An evident advantage of the disclosure corresponds to the important time saving that it is achieved by people on their pas through the doors, by avoiding the current inefficiencies caused by an inefficient or inexistent signaling.

Globally the time savings expressed in hour/man/year can reach amounts of numerous economical resources.

### BRIEF DESCRIPTION OF THE FIGURES

FIG. 1 shows a top view of four doors with a first color code modality.

FIG. 2 shows a top view of the opening of the doors according to FIG. 1.

FIG. 3 shows a top view of four doors with a second color code modality.

FIG. 5a shows a perspective view of an embodiment of the invention for one door.

FIGS. 5b and 5c show respectively perspective views of another embodiment of the invention for one door and two doors.

FIGS. 5a and 5b show respectively perspective views of another embodiment of the invention for one door and two doors.

### DETAILED DESCRIPTION OF A PREFERRED EMBODIMENT

The present disclosure provides a general door opening direction's indicator, of manual swinging doors using a color code based on the red color and the green color. The indicator has a background that is metallic grey.

Its design corresponds to a card that must be installed on each door on both sides, in the superior and opposite to the hinges part of the door, this design has two converging arrows drew in three dimensions, disposed in such way that the first arrow, if the door can only be pushed, must be green, and the second arrow red and if the door can only be pulled for its opening, the first arrow must be red and the second arrow must be green colored, the next two options correspond to blocked doors, in which case both arrows color must be red, on the other hand if the door operates in both ways (180.degree. swinging doors), the first and second arrows color must be green, (see drawings).

In this way the user anticipates the working of a series of doors that are in sequence, as always happens in places that double doors are needed for a more suitable thermal insulation, e.i., places where is needed to maintain a temperature, for example to make the air conditioning, or heating, more efficient in a place in comparison to the exterior.

Another advantage of this disclosure is that it avoids displeasure and bad humor to the people that to make their way through the doors chose doors that are currently blocked, because the current devices “push-pull” are not meant to inform of this situation. The disclosure that has being developed allows avoiding accidents that many times can be really serious.

As it was mentioned before, the indicator of the present disclosure breaks the language barrier by using colors to indicate the way that the doors operate, and it might have an easy to understand global application.

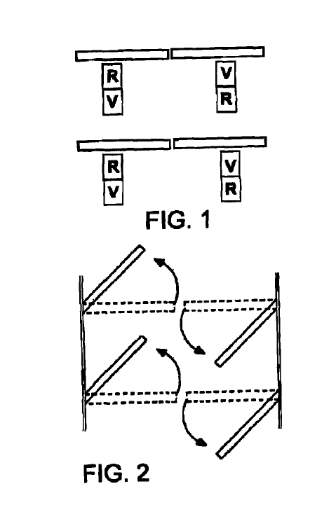

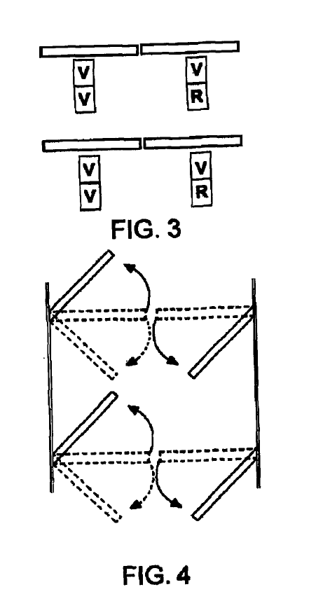

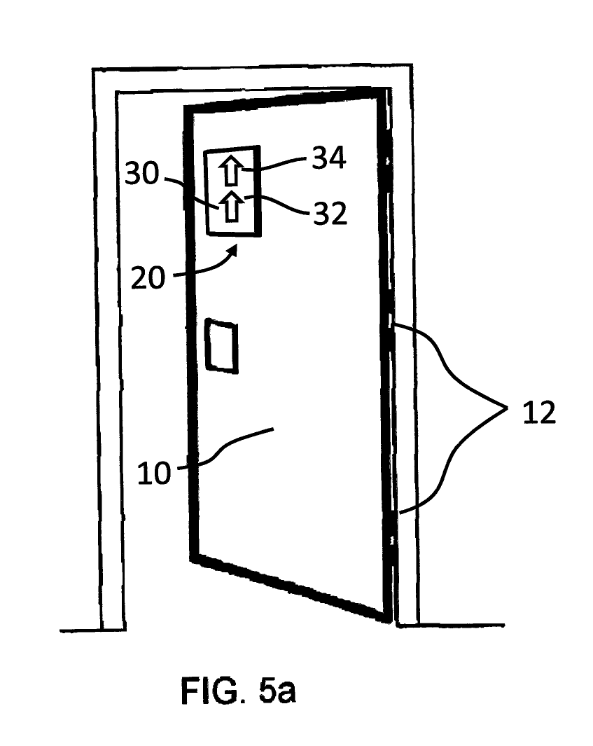

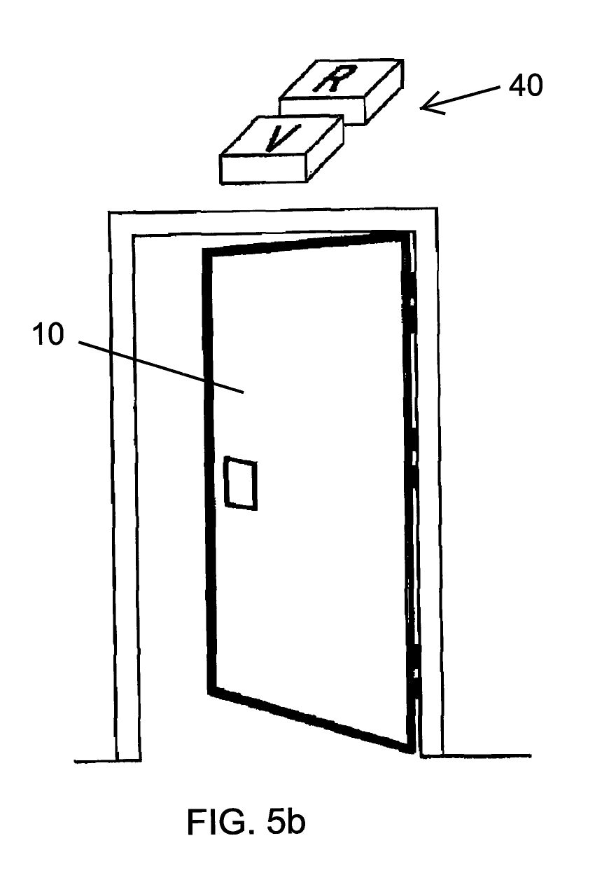

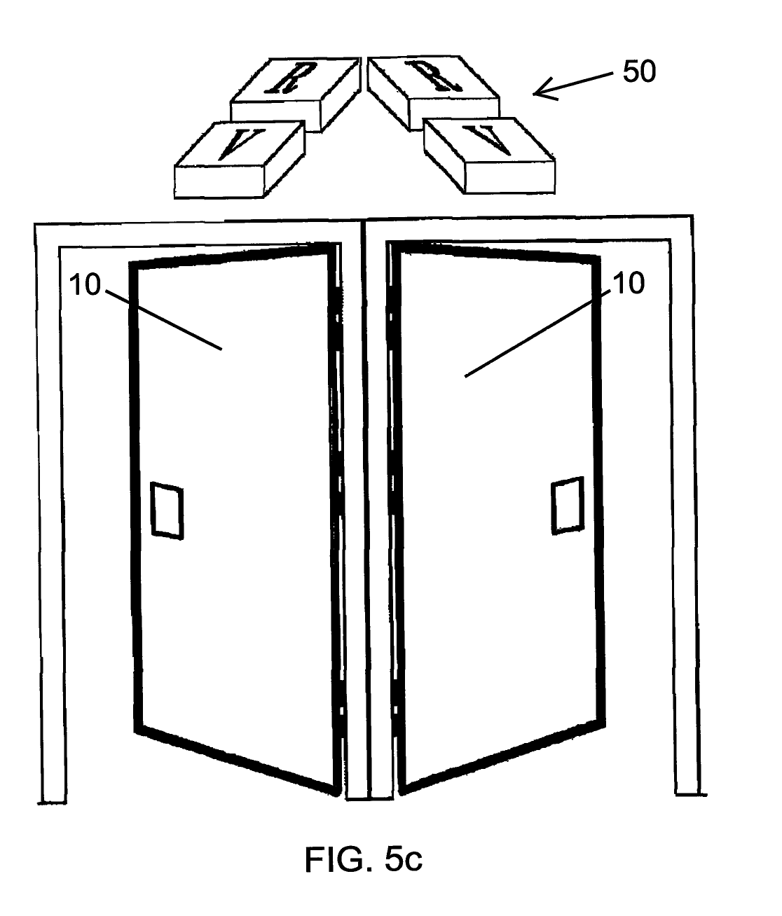

FIGS. 1 and 3 show the code for a door that comprises two colors, one for the front and one from the back of the door, wherein “R” means red and “V” means green. FIGS. 2 and 4 show how the door(s) open based on the codes shown in FIGS. 1 and 3, respectively. FIG. 5a shows the way to implement the door opening indicator 20 through a card 30 with two (2) arrows 32, 34, drawn tri-dimensionally, placed in the superior part of the door 10, on the side opposite to its support (the hinges 12), that show the door's 10 operation from the front side and the reverse side, the lower arrow 32 being the one that indicates the door's operation from the front, and the upper arrow 32 being the one that indicates the door's operation from behind.

Another embodiment of the disclosure provides a flat sign 40 in an indicator's perspective view as shown by FIG. 5b for a door 10, or a flat sign 50 as shown by FIG. 5c for two doors 10a, 10b, where it is clear that the perspective is from the front to the back of the door.

In yet another embodiment of the disclosure, the door opening indicator is a luminous device of the respecting color, wherein a luminous source of the color is placed on top of the door at both sides of it.

In another aspect of the disclosure the indicator is a panel where are disposed the color arrangement for the doors through luminous sources. The next Table shows a list of possible ways for functioning of two doors standing one next to the other.

TABLE
Color code list for different ways of
operation in the opening of doors.

| | LEFT | RIGHT |
|---|---|---|
| | DOOR | DOOR |
| 1 | R | R |
| | V | V |
| 2 | V | V |
| | R | R |
| 3 | R | V |
| | R | V |
| 4 | V | R |
| | V | R |
| 5 | R | V |
| | V | R |
| 6 | V | R |
| | R | V |
| 7 | R | V |
| | R | R |
| 8 | R | R |
| | R | V |
| 9 | R | R |
| | V | R |
| 10 | V | R |
| | R | R |
| 11 | V | R |
| | V | V |
| 12 | V | V |
| | V | R |
| 13 | R | V |
| | V | V |
| 14 | V | V |
| | R | V |

Example of an Application

An example of an application is shown on FIG. 1, wherein the door opening indicator has a configuration allowing the opening of the doors as presented in FIG. 2. Meanwhile another application example is shown in FIG. 3 possessing two of its four doors allowing for opening in both ways and directions of the doors, as it is shown in FIG. 4.

1. A method for indicating information to a person approaching a door pertaining to the opening operation of the door, without using a written language, the method comprising the steps of:
a) providing a sign that includes a first arrow associated with the operation of the door from the perspective of the approaching person for pushing the door open, wherein the color of the first arrow is selected from green and red, and a second arrow associated with the operation of the door from the perspective of the approaching person for pulling the door open, wherein the color of the second arrow is selected from green and red;
b) installing the sign on a first side of the door that can be seen by the approaching person;
c) using the green first arrow in the sign when the door can be pushed to open by the approaching person, or using the red first arrow in the sign when the door cannot be pushed by the approaching person; and
d) using the green second arrow in the sign when the door can be pulled to open by the approaching person, or using the red first arrow in the sign when the door cannot be pulled to open by the approaching person.

2. The method according to claim 1 wherein when the door can be both pushed to open and pulled to open by the approaching person, the green first arrow and the green second arrow are used in the sign.

3. The method according to claim 1 wherein when the door cannot be either pushed to open and pulled to open by the approaching person, the red first arrow and the red second arrow are used in the sign.

4. The method according to claim 1, further including installing another sign on an opposite side of the door, to indicate information to another person approaching the door from the opposite direction.

5. The method according to claim 1, wherein the door has hinges and the sign is installed on an upper part of the door opposite the hinges of the door.

6. The method according to claim 1, wherein the door is a manually-operated door.

7. The method according to claim 1, wherein the size of the sign is provided so that the sign can be seen by an approaching person at a distance of from 4 to 5 meters from the door.

8. The method according to claim 1, wherein the sign is installed on top of the door.

9. The method according to claim 1, wherein a second door is disposed next to the door, further including the step of installing a second sign on a first side of the second door that can be seen by the approaching person.

10. The method according to claim 1, wherein the sign is a card on which the first arrow and the second arrow are in three-dimensional form.

11. The method according to claim 1, wherein the sign has a background, and the color of the background is metallic grey.

12. A method for indicating information to a person approaching a door pertaining to the opening operation of the door, without using a written language, the method comprising the steps of:
a) providing an luminous indicator that includes a first panel associated with the operation of the door from the perspective of the approaching person for pushing the door open, wherein the illuminating color of the first panel is selected from green and red, and a second panel associated with the operation of the door from the perspective of the approaching person for pulling the door open, wherein the illuminating color of the second panel is selected from green and red;
b) installing the luminous indicator a first side and on top of the door that can be seen by the approaching person;
c) illuminating the first panel to the green color when the door can be pushed to open by the approaching person, or illuminating the first panel to the red color when the door cannot be pushed to open by the approaching person; and
d) illuminating the second panel to the green color when the door can be pulled to open by the approaching person, or illuminating the second panel to the red color when the door cannot be pulled to open by the approaching person.

13. The method according to claim 12, further including installing another luminous indicator on an opposite side of the door, to indicate information to another person approaching the door from the opposite direction concerning the opening operation of the door from the opposite direction.

14. The method according to claim 12, wherein a second door is disposed next to the door, further including the step of installing a second luminous indicator on a first side of the second door that can be seen by the approaching person.

15. A method of informing a person approaching a door concerning the opening operation of the door, without using a written language, the method comprising the steps of:
1) providing a sign that includes a first arrow, the first arrow selected from a first green- colored arrow and a first red-colored arrow, and a second arrow, the second arrow selected from a second green-colored arrow and a second red-colored arrow,
2) installing the sign on a first side of a door that can be seen by the approaching person;
3) placing the sign in a state selected from at least one of the following states:
a) a first state in which the sign includes a first green-colored arrow and a second green-colored arrow, to inform the approaching person that the door can be operated to open by pushing open the door, or by pulling open the door;
b) a second state in which the sign includes a first red-colored arrow and a second red-colored arrow, to inform the approaching person that the door cannot be operated to open by either pushing on the door, or by pulling on the door;
c) a third state in which the sign includes a first green-colored arrow and a second red-colored arrow, to inform the approaching person that the door can be operated to open by pushing open the door, but cannot be operated to open by pulling on the door; and
d) a fourth state in which the sign includes a first red-colored arrow and a second green-colored arrow, to inform the approaching person that the door cannot be operated to open by pushing on the door, but can be operated to open by pulling open the door.

16. The method according to claim 15, further including installing another sign on an opposite side of the door, to inform another person approaching the door from the opposite direction concerning the opening operation of the door from the opposite direction.

17.-25. (canceled)
